(19) United States
(12) Patent Application Publication
(10) Pub. No.: US 2018/0208776 A1
(43) Pub. Date: Jul. 26, 2018

(54) HARDCOAT FILM, FRONT PLATE OF IMAGE DISPLAY ELEMENT, RESISTIVE FILM-TYPE TOUCH PANEL, CAPACITANCE-TYPE TOUCH PANEL, AND IMAGE DISPLAY

(71) Applicant: FUJIFILM Corporation, Tokyo (JP)

(72) Inventors: Keigo UEKI, Kanagawa (JP); Katsuyuki TAKADA, Kanagawa (JP)

(73) Assignee: FUJIFILM Corporation, Tokyo (JP)

(21) Appl. No.: 15/928,620

(22) Filed: Mar. 22, 2018

Related U.S. Application Data
(63) Continuation of application No. PCT/JP2016/078743, filed on Sep. 28, 2016.

(30) Foreign Application Priority Data
Sep. 29, 2015 (JP) 2015-192343

(51) Int. Cl. C09D 4/00; B32B 27/30; B32B 27/36; B32B 23/04; B32B 23/16; B32B 27/08; G02B 1/14

(52) U.S. Cl. CPC C09D 4/00; B32B 27/308; B32B 27/365; B32B 23/04; B32B 23/16; B32B 27/08; B32B 2457/206; G02B 1/14; B32B 2255/10; B32B 2255/26; B32B 2307/58; B32B 2457/202; B32B 2457/208; B32B 27/36

(57) ABSTRACT

Provided is a hardcoat film, which has at least a first cured layer, a support, and a second cured layer in this order and in which the first cured layer contains a cured substance of an epoxy group-containing curable compound, the second cured layer contains a cured substance of a (meth)acryloyl group-containing curable compound, a content rate of the cured substance of the epoxy group-containing curable compound in the second cured layer is lower than a content rate of the cured substance of the epoxy group-containing curable compound in the first cured layer, and Expression (1) is satisfied, and provided a front plate of an image display, a resistive film-type touch panel, a capacitance-type touch panel, and an image display in which the hardcoat film is used: Expression (1): 7>(film thickness of first cured layer/film thickness of second cured layer)>1.

### CROSS REFERENCE TO RELATED APPLICATIONS

This is a continuation of International Application No. PCT/JP2016/078743 filed on Sep. 28, 2016, and claims priority from Japanese Patent Application No. 2015-192343 filed on Sep. 29, 2015, the entire disclosures of which are incorporated herein by reference.

### BACKGROUND OF THE INVENTION

### 1. Field of the Invention

The present invention relates to a hardcoat film, a front plate of an image display element, a resistive film-type touch panel, a capacitance-type touch panel, and an image display. Specifically, the present invention relates to a hardcoat film which has excellent surface smoothness and excellent cutting properties, and a front plate of an image display element, a resistive film-type touch panel, a capacitance-type touch panel, and an image display in which the hardcoat film is used.

### 2. Description of the Related Art

In the related art, for the uses in which high durability is required for a front plate of an image display, a substrate of a touch panel, and the like, glass such as chemical strengthening glass is mainly used. Compared to the glass, plastic has advantages such as lightweightness, resistance to cracking, and thinness. Therefore, in recent years, in the uses in which glass is mainly utilized, the usefulness of plastic as a material substituting glass has drawn attention. Particularly, a film having a functional layer (a cured layer) on both surfaces of a support has been used.

Especially, for a film used on a surface of a touch panel, the surface smoothness is considered important. Therefore, as a method for smoothing the surface of the film, for example, a method is known in which an epoxy group-containing curable compound (epoxy-based compound) less experiencing cure shrinkage is used in a cured layer.

As a film containing an epoxy-based resin in a functional layer, for example, JP2008-262147A discloses an optical laminated film having a base material layer formed of polyethylene terephthalate (PET), a light-diffusing layer which is laminated on an upper surface of the base material layer and contains, for example, acrylic particles and a binder resin, and a coating layer which is laminated on a lower surface of the base material layer and contains, for example, an acrylic compound and a UV-curable epoxy binder resin.

Furthermore, JP2013-123825A describes a hardcoat film having, for example, a base material layer which contains a PET-based resin as a main component and first and third hardcoat layers which are formed on both surfaces of the base material layer and contain resins formed of acrylate or epoxides as main components.

### SUMMARY OF THE INVENTION

However, it cannot be said that the optical laminated film described in JP2008-262147A and the hardcoat film described in JP2013-123825A have excellent punching processability (cutting properties), and the films have a problem in that the edge of the front surface and the rear surface of the films cracks at the time of punching.

The present invention has been made to solve the above problem, and an object of the present invention, that is, a solution to the problem to be solved by the present invention is to provide a hardcoat film which has excellent surface smoothness and excellent cutting properties. Another object of the present invention is to provide a front plate of an image display element, a resistive film-type touch panel, a capacitance-type touch panel, and an image display in which the aforementioned hardcoat film is used.

In order to solve the above problem, the inventors of the present invention conducted an intensive examination. As a result, the inventors found that the above problem can be solved by the following means.

As described above, in a case where an epoxy-based compound is used in a touch panel-side cured layer on a surface of a film, the surface of the film can have excellent smoothness. However, because the epoxy-based compound is flexible, in order for the film used on the surface of the touch panel to maintain required hardness, a thick cured layer needs to be formed on both surfaces of a support. As a result, the total film thickness of the film is increased, and hence the punching processability (cutting properties) deteriorates.

In contrast, in a case where a cured layer formed on a surface opposite to the touch panel-side surface is made thinner than the touch panel-side cured layer so as to make a thin film, the film is distorted. Consequently, as in a case where the film thickness is increased, the cutting properties deteriorate, and the edge of the front surface and the rear surface of the film cracks.

The inventors of the present invention presume that the edge cracking of the cured layer occurring at the time of punching process may result from the deformation of the hardcoat film. That is, in a case where an entirely deformed hardcoat film is kept such that the film becomes smooth at the time of punching, stress is partially applied to the film, and hence the film is distorted. Then, at the moment the distorted portion is punched with a blade, the stress applied to the film is relaxed all at once. As a result, the punched portion bounces to restore its original shape. The inventors consider that due to the impact, the edge cracks.

According to the present invention, a first cured layer containing a cured substance of an epoxy-based compound is provided on one surface of a support, a second cured layer containing a cured substance of a (meth)acryloyl group-containing curable compound (acrylic compound) is provided on the other surface of the support, and a ratio between content rates of the cured substances of the epoxy-based compound in the first and second cured layers as well as a ratio between film thicknesses of the cured layers are appropriately restricted. As a result, the film deformation can be prevented, and a hardcoat film satisfying both the surface smoothness and the cutting properties can be obtained.

That is, the present invention is constituted as below.

[1] A hardcoat film comprising at least a first cured layer, a support, and a second cured layer in this order, in which the first cured layer contains a cured substance of an epoxy group-containing curable compound, the second cured layer contains a cured substance of a (meth)acryloyl group-containing curable compound, a content rate of the cured substance of the epoxy group-containing curable compound in the second cured layer is lower than a content rate of the cured substance of the epoxy group-containing curable compound in the first cured layer, and Expression (1) is satisfied.

7>(film thickness of first cured layer/film thickness of second cured layer)>1 Expression (1):

[2] The hardcoat film described in [1], comprising a compound having an alicyclic structure as the epoxy group-containing curable compound.

[3] The hardcoat film described in [1] or [2], in which a content rate of inorganic particles in the second cured layer is equal to or lower than 10% by mass.

[4] The hardcoat film described in any one of [1] to [3], in which the support has at least a first layer, a second layer, and a third layer in this order.

[5] The hardcoat film described in [4], in which the second layer is formed of a material different from materials of the first layer and the third layer, and a film thickness of the first layer and the third layer is equal to or greater than 15 μm and less than 60 μm.

[6] The hardcoat film described in [5], in which the first layer and the third layer are formed of the same material.

[7] A front plate of an image display, comprising the hardcoat film described in any one of [1] to [6].

[8] A resistive film-type touch panel comprising the front plate described in [7].

[9] A capacitance-type touch panel comprising the front plate described in [7].

[10] An image display comprising the front plate described in [7] and an image display element.

[11] The image display described in [10], in which the image display element is a liquid crystal display element.

[12] The image display described in [10], in which the image display element is an organic electroluminescence display element.

[13] The image display described in any one of [10] to [12], in which the image display element is an in-cell touch panel display element.

[14] The image display described in any one of [10] to [12], in which the image display element is an on-cell touch panel display element.

According to the present invention, it is possible to provide a hardcoat film having excellent surface smoothness and excellent cutting properties. Furthermore, it is possible to provide a front plate of an image display element, a resistive film-type touch panel, a capacitance-type touch panel, and an image display in which the hardcoat film is used.

### DESCRIPTION OF THE PREFERRED EMBODIMENTS

Hereinafter, the present invention will be specifically described.

In the present specification, “to” is a term including the numerical values listed before and after “to” are a lower limit and an upper limit.

In the present specification. “(meth)acryl group” means “either or both the acryl group and the methacryl group”. The same is true for a (meth)acrylic acid, a (meth)acrylamide, a (meth)acryloyl group, and the like.

[Hardcoat Film]

The hardcoat film of the present invention is a hardcoat film having at least a first cured layer, a support, and a second cured layer in this order, in which the first cured layer contains a cured substance of an epoxy group-containing curable compound, the second cured layer contains a cured substance of a (meth)acryloyl group-containing curable compound, a content rate of the cured substance of the epoxy group-containing curable compound in the second cured layer is lower than a content rate of the cured substance of the epoxy group-containing curable compound in the first cured layer, and Expression (1) is satisfied.

7>(film thickness of first cured layer/film thickness of second cured layer)>1 Expression (1):

Hereinbelow, preferable aspects of the hardcoat film of the present invention will be described.

[Support]

The support may be a single-layered film consisting of one resin layer or a laminated film consisting of two or more resin layers. “Resin” is a term including an oligomer, a prepolymer, and a polymer in meaning.

The support is available as a commercial product or can be manufactured by a known film forming method. As the commercial support, for example, it is possible to use TECHNOLLOY C101 and TECHNOLLOY C001 (all manufactured by Escarbo Sheet Company. Ltd.), AW-10 (manufactured by Wavelock Advanced Technology Co., Ltd.), and the like.

Examples of resin films that can be used as the support include an acrylic resin film, a polycarbonate-based resin film, a triacetyl cellulose (TAC)-based resin film, a polyethylene terephthalate (PET)-based resin film, a polyolefin-based resin film, a polyester-based resin film, an acrylonitrile-butadiene-styrene copolymer film, and the like.

In a preferred aspect, a resin film that can be used as the support is at least one kind of film selected from the group consisting of an acrylic resin film, a triacetyl cellulose-based resin film, and polyethylene terephthalate- and polycarbonate-based resin films.

In a preferred aspect, the resin film contained in the support is a laminated film having two or more layers of resin films, and is preferably a laminated film having at least one layer of acrylic resin film and at least one layer of polycarbonate-based resin film. The number of films laminated is preferably two or three. In the present invention, it is preferable that the support has at least a first layer, a second layer, and a third layer in this order. It is preferable that in the support in the hardcoat film of the present invention, the second layer is formed of a material different from materials of the first layer and the third layer.

Furthermore, it is preferable that the first layer and the third layer are formed of the same material.

As an example of a more preferred support (laminated film), a laminated film can be exemplified which has an acrylic resin film, a polycarbonate-based resin film, and an acrylic resin film in this order. The acrylic resin film refers to a resin film of a polymer or a copolymer containing one or more kinds of monomers selected from the group consisting of an acrylic acid ester and a methacrylic acid ester, and for example, a polymethyl methacrylate resin (PMMA) film is particularly preferable.

(Optional Component of Support)

The support can also optionally contain one or more kinds of components as other components such as known additives in addition to a resin. As an example of the components that can be optionally contained in the support, an ultraviolet absorber can be exemplified. Examples of the ultraviolet absorber include a benzotriazole compound and a triazine compound. The benzotriazole compound is a compound having a benzotriazole ring, and specific examples thereof include various benzotriazole-based ultraviolet absorbers described in paragraph “0033” in JP2013-111835A. The triazine compound is a compound having a triazine ring, and specific examples thereof include various triazine-based ultraviolet absorbers described in paragraph “0033” in JP2013-111835A. The content of the ultraviolet absorber in the resin film is, for example, about 0.1 to 10 parts by mass with respect to 100 parts by mass of the resin contained in the film, but is not particularly limited. Regarding the ultraviolet absorber, paragraph “0032” in JP2013-111835A can also be referred to. In the present invention and the present specification, ultraviolet rays mean the light having a central emission wavelength in a wavelength range of 200 to 380 nm.

(Film Thickness of Support)

From the viewpoint of improving pencil hardness, the film thickness of the support in the hardcoat film of the present invention is preferably 80 to 400 μm, more preferably 100 to 300 μm, and particularly preferably 100 to 200 μm.

In a case where the support has at least the first layer, the second layer, and the third layer in this order, the film thickness of the first layer and the third layer is preferably equal to or greater than 15 μm and less than 60 μm.

[Cured Layer]

The hardcoat film of the present invention has at least the first cured layer, the support, and the second cured layer in this order.

In the present invention, a cured layer refers to a layer having a pencil hardness of equal to or higher than 2H which is measured on the surface of the layer.

<First Cured Layer>

The first cured layer in the hardcoat film of the present invention contains a cured substance of an epoxy group-containing curable compound (epoxy-based compound).

The epoxy-based compound is not particularly limited as long as it has one or more epoxy groups. The epoxy-based compound is preferably alicyclic, and a molecular weight of the compound is preferably equal to or smaller than 300, more preferably equal to or smaller than 210, and even more preferably equal to or smaller than 200.

In a case where the molecular weight is equal to or smaller than 300, the number of moieties other than an epoxy group or an ethylenically unsaturated double bond group is reduced, and hence the pencil hardness can be improved.

From the viewpoint of inhibiting volatilization at the time of forming the cured layer, the molecular weight of the epoxy-based compound is preferably equal to or greater than 100 and more preferably equal to or greater than 150.

The epoxy-based compound preferably has one alicyclic epoxy group and one ethylenically unsaturated double bond group in a molecule, more preferably has a molecular weight of equal to or smaller than 300, and is even more preferably a compound represented by General Formula (1).

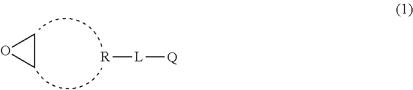

In General Formula (1), R represents monocyclic hydrocarbon or cross-linked hydrocarbon, L represents a single bond or a divalent linking group, and Q represents an ethylenically unsaturated double bond group.

In a case where R in General Formula (1) is monocyclic hydrocarbon, the monocyclic hydrocarbon is preferably alicyclic hydrocarbons. Among these, an alicyclic group having 4 to 10 carbon atoms is more preferable, an alicyclic group having 5 to 7 carbon atoms is even more preferable, and an alicyclic group having 6 carbon atoms is particularly preferable. Specifically, a cyclobutyl group, a cyclopentyl group, a cyclohexyl group, and a cycloheptyl group are preferable, and a cyclohexyl group is particularly preferable.

In a case where R in General Formula (1) is cross-linked hydrocarbon, a bicyclic crosslink (bicyclo ring) and a tricyclic crosslink (tricyclo ring) are preferable, and examples thereof include cross-linked hydrocarbon having 5 to 20 carbon atoms. Examples of the cross-linked hydrocarbon include a norbornyl group, a bornyl group, an isobornyl group, a tricyclodecyl group, a dicyclopentenyl group, dicyclopentanyl group, a tricyclopentenyl group, a tricyclopentanyl group, an adamantyl group, an adamantyl group substituted with a lower alkyl group, and the like.

In a case where L represents a divalent linking group, a divalent aliphatic hydrocarbon group is preferable. The number of carbon atoms in the divalent aliphatic hydrocarbon group is preferably 1 to 6, more preferably 1 to 3, and even more preferably 1. The divalent aliphatic hydrocarbon group is preferably a linear, branched, or cyclic alkylene group, more preferably a linear or branched alkylene group, and even more preferably a linear alkylene group.

Examples of Q include polymerizable functional groups such as a (meth)acryloyl group, a vinyl group, a styryl group, and an allyl group. Among these, a (meth)acryloyl group and —C(O)OCH═CH₂ are preferable, and a (meth)acryloyl group is particularly preferable.

In the present invention, in a case where the epoxy-based compound has a (meth)acryloyl group, the compound is regarded as “epoxy-based compound” but is not regarded as “(meth)acryloyl-based compound”.

Specific examples of the epoxy-based compound are not particularly limited as long as the examples include curable compounds having an epoxy group. As the compound, it is possible to use the compound described in paragraph “0015” in JP1998-17614A (JP-H10-17614A), a compound represented by General Formula (1A) or (1B), 1,2-epoxy-4-vinylcvclohexane, and the like.

Among these, the compound represented by General Formula (1A) or (1B) is more preferable, and the compound represented by General Formula (1A) having a low molecular weight is even more preferable. An isomer of the compound represented by General Formula (1A) is also preferable. In General Formula (1A), L₂ represents a divalent aliphatic hydrocarbon group having 1 to 6 carbon atoms. The number of carbon atoms in L₂ is more preferably 1 to 3. From the viewpoint of improving smoothness, the number of carbon atoms in L₂ is even more preferably 1 (that is, the compound represented by General Formula (1A) is even more preferably epoxycyclohexyl methyl (meth)acrylate).

By using these compounds, it is possible to simultaneously achieve both of the high pencil hardness and the excellent smoothness at a higher level.

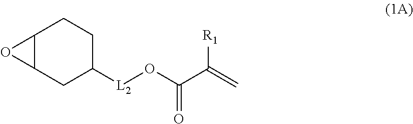

In General Formula (1A), R₁ represents a hydrogen atom or a methyl group, and L₂ represents a divalent aliphatic hydrocarbon group having 1 to 6 carbon atoms.

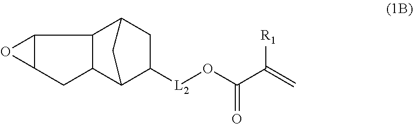

In General Formula (1B), R₁ represents a hydrogen atom or a methyl group, and L₂ represents a divalent aliphatic hydrocarbon group having 1 to 6 carbon atoms.

The number of carbon atoms in the divalent aliphatic hydrocarbon group represented by L₂ in General Formulae (1A) and (1B) is 1 to 6, more preferably 1 to 3, and even more preferably 1. The divalent aliphatic hydrocarbon group is preferably a linear, branched, or cyclic alkylene group, more preferably a linear or branched alkylene group, and even more preferably a linear alkylene group.

Provided that the total solid content of the first cured layer is 100% by mass, the content of the cured substance of the epoxy-based compound is preferably 10% to 70% by mass. Provided that the total solid content of a resin composition for forming the first cured layer is 100% by mass, the content of the epoxy-based compound is preferably 15% to 70% by mass. In a case where the content of the cured substance of the epoxy-based compound with respect to the first cured layer is equal to or greater than 10% by mass, the effect of improving surface smoothness can be sufficiently obtained. In contrast, in a case where the content of the cured substance of the epoxy-based compound with respect to the first cured layer is equal to or smaller than 70% by mass, the surface hardness can be sufficiently improved.

As another example of the cyclic structure contained in the epoxy-based compound, a nitrogen-containing heterocyclic ring can be exemplified. The compound containing a nitrogen-containing heterocyclic ring is a cationically polymerizable compound which is preferred from the viewpoint of forming a cured layer exhibiting excellent adhesiveness with respect to the support in the hardcoat film. As the compound containing a nitrogen-containing heterocyclic ring, a compound is preferable which has one or more nitrogen-containing heterocyclic rings selected from the group consisting of an isocyanurate ring (nitrogen-containing heterocyclic ring contained in example compounds B-1 to B-3 which will be described later) and a glycoluril ring (nitrogen-containing heterocyclic ring contained in an example compound B-10 which will be described later) in one molecule. Among these, from the viewpoint of forming a cured layer exhibiting excellent adhesiveness with respect to the support in the hardcoat film, the compound containing an isocyanurate ring (isocyanurate ring-containing compound) is more preferred as a cationically polymerizable compound, because, according to the inventors of the present invention, the isocyanurate ring is assumed to have excellent affinity with the resin constituting the support. In this respect, a support containing an acrylic resin film is more preferable, and it is even more preferable that the surface directly in contact with the cured layer is the surface of the acrylic resin film.

As another example of the cyclic structure contained in the cyclic structure-containing compound, an alicyclic structure can be exemplified. Examples of the alicyclic structure include a cyclo ring, a dicyclo ring, and a tricyclo ring structures. Specific examples thereof include a dicyclopentanyl ring, a cyclohexane ring, and the like.

The cationically polymerizable compound described so far can be synthesized by a known method, and can be obtained as a commercially available product.

Specific examples of the epoxy-based compound include 3,4-epoxycyclohexylmethyl methacrylate (commercially available products such as CYCLOMER M-100 manufactured by DAICEL CORPORATION), 3,4-epoxycyclohexylmethyl-3′,4′-epoxycyclohexane carboxylate (for example, commercially available products such as UVR 6105 and UVR 6110 manufactured by Union Carbide Corporation and CELLOXIDE 2021 manufactured by Daicel Corporation), bis(3,4-epoxycyclohexylmethyl)adipate (for example, UVR 6128 manufactured by Union Carbide Corporation), vinylcyclohexene monoepoxide (for example, CELLOXIDE 2000 manufactured by DAICEL CORPORATION), ϵ-caprolactam-modified 3,4-epoxycyclohexylmethyl 3′,4′-epoxycyclohexane carboxylate (for example, CELLOXIDE 2081 manufactured by DAICEL CORPORATION), glycerol polyglycidyl ether (for example, DENACOL EX-314 manufactured by Nagase ChemteX Corporation), and the like.

As specific examples of the epoxy-based compound, example compounds B-1 to B-10 will be shown below, but the present invention is not limited to the following specific examples.

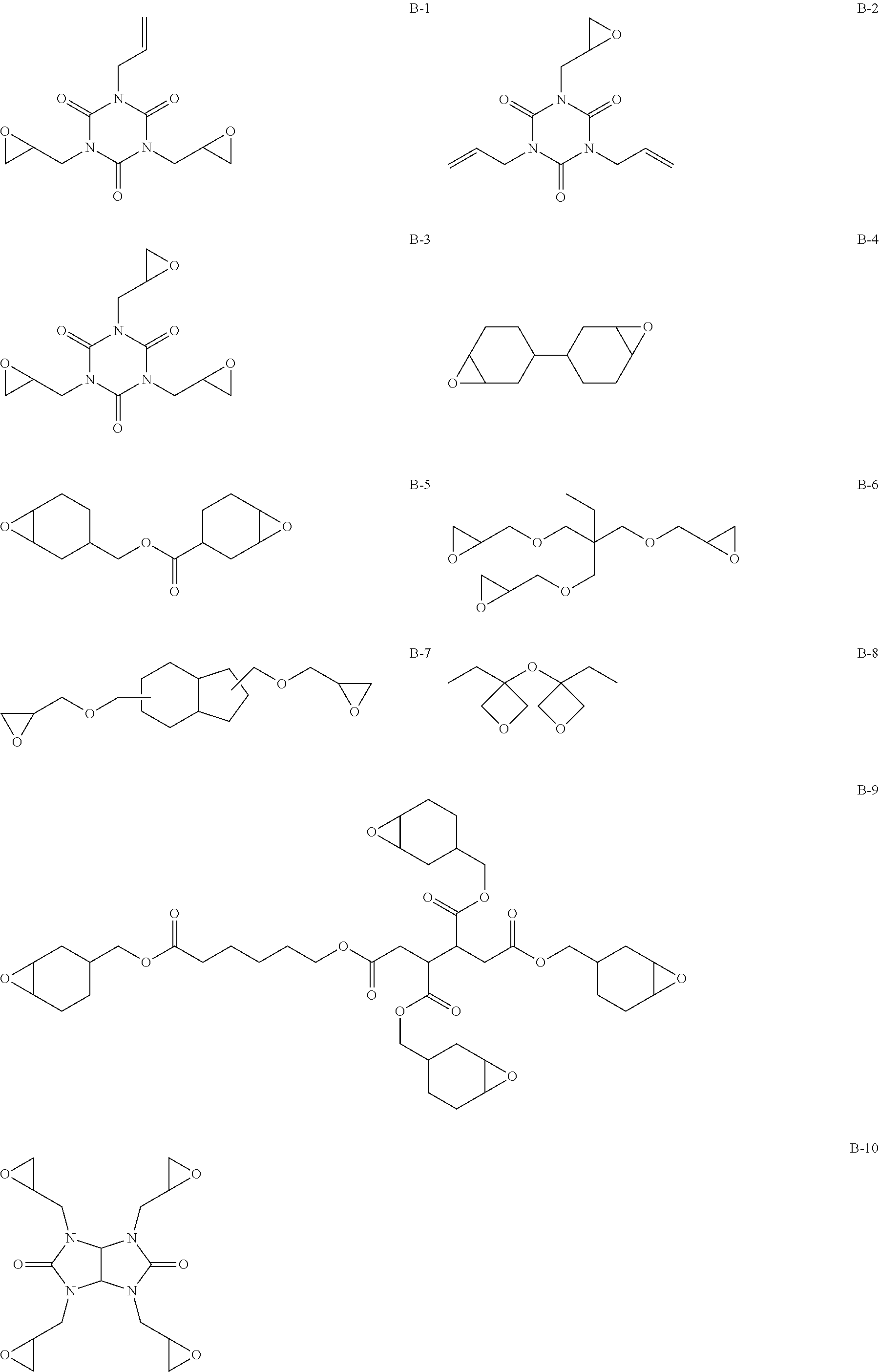

(Constitution of First Cured Layer)

In the hardcoat film of the present invention, the film thickness of the cured layer is greater than 10 μm. From the viewpoint of increasing pencil hardness, it is preferable that the cured layer has a large film thickness. In contrast, from the viewpoint of increasing surface roughness, it is preferable that the film thickness of the cured layer is somewhat small. The film thickness of the cured layer is preferably greater than 10 μm and equal to or smaller than 60 μm, more preferably 15 to 50 μm, more preferably 15 to 40 μm, and particularly preferably 15 to 30 μm.

<Second Cured Layer>

The second cured layer in the hardcoat film of the present invention contains a cured substance of a (meth)acryloyl group-containing curable compound ((meth)acryloyl-based compound). The content rate of the cured substance of the epoxy group-containing curable compound in the second cured layer is lower than the content rate of the cured substance of the epoxy group-containing curable compound in the first cured layer.

The number of (meth)acryloyl groups in one molecule of the (meth)acryloyl-based compound is not limited. From the viewpoint of cutting properties, a compound having two or more (meth)acryloyl groups in one molecule is preferable, a compound having three or more (meth)acryloyl groups in one molecule is more preferable, and a compound having six or more (meth)acryloyl groups in one molecule is even more preferable. Examples of the compound include (meth)acrylate-based compounds for forming a cured substance having high hardness that are widely used in the field of the related art.

Examples of the (meth)acrylate-based compounds include esters of a polyhydric alcohol and a (meth)acrylic acid {for example, ethylene glycol di(meth)acrylate, butanediol di(meth)acrylate, hexanediol di(meth)acrylate, 1,4-cyclohexanediacrylate, pentaerythritol tetra(meth)acrylate, pentaerythritol tri(meth)acrylate, trimethylolpropane tri(meth)acrylate, ethylene oxide (EO)-modified trimethylolpropane tri(meth)acrylate, propylene oxide (PO)-modified trimethylolpropane tri(meth)acrylate, EO-modified photphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexanetetramethacrylate, polyurethane polyacrylate, polyester polyacrylate, and caprolactone-modified tris(acryloxyethyl)isocyanurate}, and the like.

The molecular weight of the above (meth)acrylate-based compound is preferably equal to or greater than 200 and less than 3,000. In the present invention, for a multimer, a molecular weight refers to a weight-average molecular weight which is measured by gel permeation chromatography (GPC) and expressed in terms of polystyrene. As an example of specific measurement conditions for the weight-average molecular weight, the following measurement conditions can be exemplified.

GPC device: HLC-8120 (manufactured by Tosoh Corporation)

Column: TSK gelMultipore HXL-M (manufactured by Tosoh Corporation, 7.8 mm ID (inside diameter)×30.0 cm)

Eluent: tetrahydrofuran (THF)

As the (meth)acrylate-based compound, a compound (urethane (meth)acrylate) having one or more urethane bonds together with the aforementioned acryloyl group in one molecule is also preferable.

Examples of commercial products of the urethane (meth)acrylate include, but are not limited to, UA-306H, UA-306I, UA-306T, UA-510H, UF-8001G, UA-101I, UA-101T, AT-600, AH-600, and AI-600 manufactured by KYOEISHA CHEMICAL Co., LTD., U-4HA, U-6HA, U-6LPA, UA-32P, U-15HA, and UA-1100H manufactured by SHIN-NAKAMURA CHEMICAL CO., LTD., SHIKOH UV-1400B, SHIKOH UV-1700B, SHIKOH UV-6300B, SHIKOH UV-7550B, SHIKOH UV-7600B, SHIKOH UV-7605B, SHIKOH UV-7610B, SHIKOH UV-7620EA, SHIKOH UV-7630B, SHIKOH UV-7640B, SHIKOH UV-6630B, SHIKOH UV-7000B, SHIKOH UV-7510B, SHIKOH UV-7461TE, SHIKOH UV-3000B, SHIKOH UV-3200B, SHIKOH UV-3210EA, SHIKOH UV-3310EA, SHIKOH UV-3310B, SHIKOH UV-3500BA, SHIKOH UV-3520TL, SHIKOH UV-3700B, SHIKOH UV-6100B, SHIKOH UV-6640B, SHIKOH UV-2000B, SHIKOH UV-2010B, SHIKOH UV-2250EA, and SHIKOH UV-2750B manufactured by Nippon Synthetic Chemical Industry Co., Ltd, UL-503LN manufactured by KYOEISHA CHEMICAL Co., LTD., UNIDIC 17-806, UNIDIC 17-813, UNIDIC V-4030, and UNIDIC V-4000BA manufactured by DIC Corporation, EB-1290K manufactured by Daicel-UCB Company, Ltd., HI-COAP AU-2010 and HI-COAP AU-2020 manufactured by TOKUSHIKI Co., Ltd., and the like.

As specific examples of the urethane (meth)acrylate, example compounds A-1 to A-8 will be shown below, but the present invention is not limited to the following specific examples.

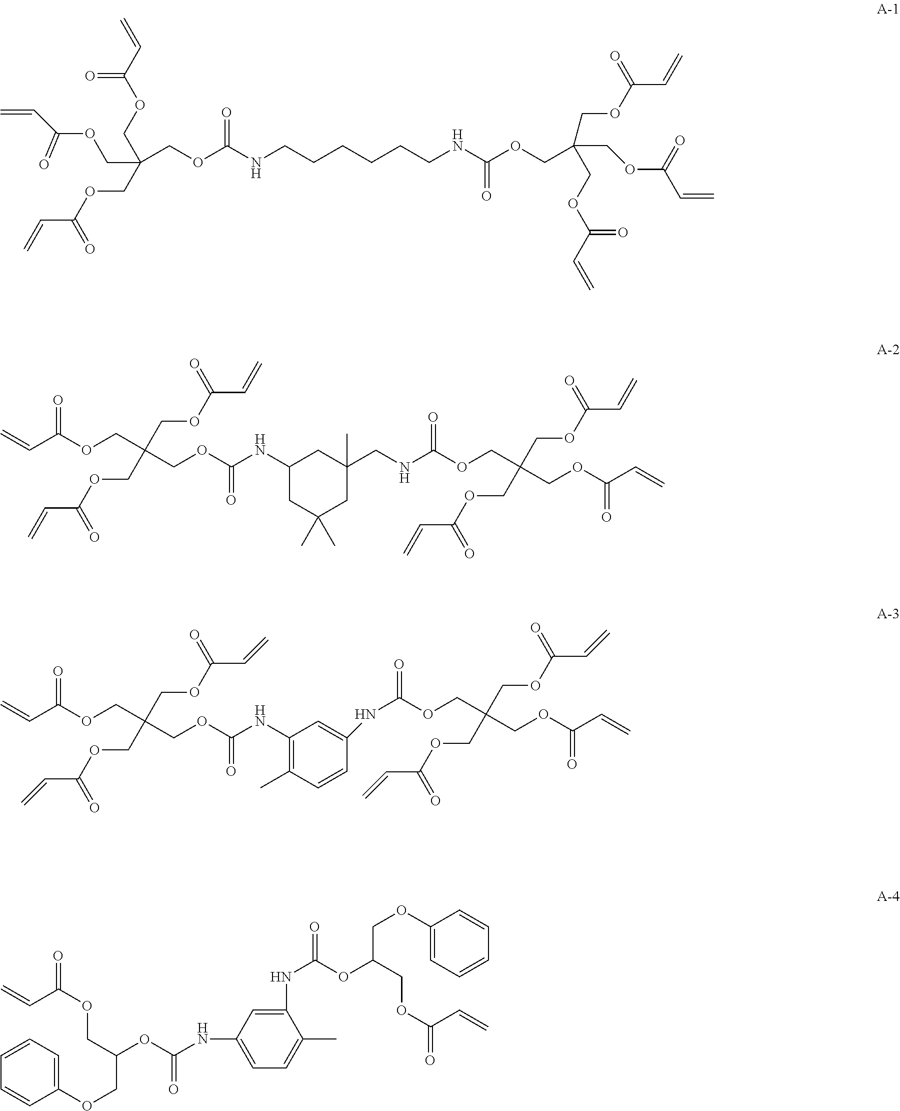

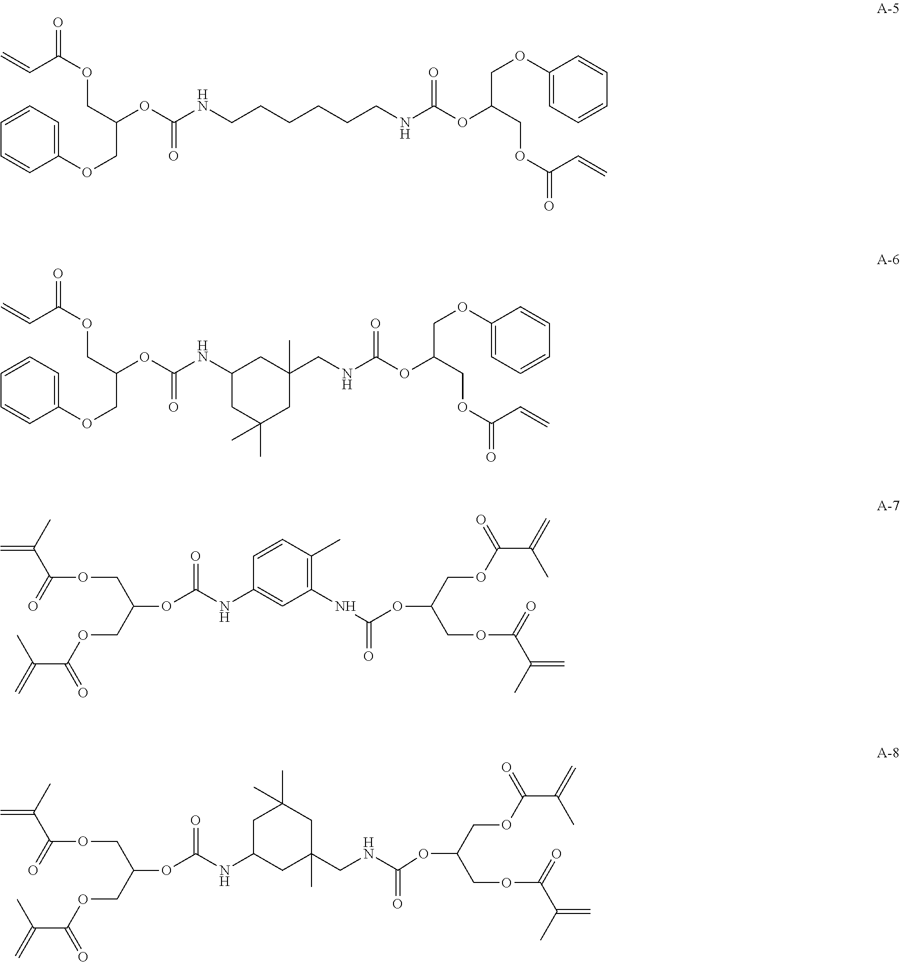

In the present invention, the (meth)acrylate-based compound contained in the second cured layer may be a compound not having a urethane bond.

Examples of the (meth)acrylate-based compound not having a urethane bond include the following compounds, but the present invention is not limited to the following example compounds.

Examples of the (meth)acrylate-based compound not having a urethane bond include difunctional (meth)acrylate compounds such as polyethylene glycol 200 di(meth)acrylate, polyethylene glycol 300 di(meth)acrylate, polyethylene glycol 400 di(meth)acrylate, polyethylene glycol 600 di(meth)acrylate, triethylene glycol di(meth)acrylate, epichlorohydrin-modified ethylene glycol di(meth)acrylate (as a commercial product, for example, DENACOL DA-811 manufactured by NAGASE & CO., LTD or the like), polypropylene glycol 200 di(meth)acrylate, polypropylene glycol 400 di(meth)acrylate, polypropylene glycol 700 di(meth)acrylate, ethylene oxide (EO).propylene oxide (PO) block polyether di(meth)acrylate (as a commercial product, for example, a BLEMMER PET series manufactured by NOF CORPORATION or the like), dipropylene glycol di(meth)acrylate, bisphenol AEO-added di(meth)acrylate (as commercial products, M-210 manufactured by TOAGOSEI CO., LTD., NK ESTER A-BPE-20 manufactured by SHIN-NAKAMURA CHEMICAL CO., LTD., and the like), hydrogenated bisphenol A EO-added di(meth)acrylate (NK ESTER A-HPE 4 manufactured by SHIN-NAKAMURA CHEMICAL CO., LTD., and the like), bisphenol A PO-added di(meth)acrylate (as a commercial product, for example, LIGHT ACRYLATE BP-4PA manufactured by KYOEISHA CHEMICAL Co., LTD, or the like), bisphenol A epichlorohydrin-added di(meth)acrylate (as a commercial product, for example, EBECRYL 150 manufactured by Daicel-UCB Company, Ltd., or the like), bisphenol A EO-PO-added di(meth)acrylate (as a commercial product, for example, BP-023-PE manufactured by TOHO Chemical Industry Co., Ltd., or the like), bisphenol F EO-added dimethacrylate (as a commercial product, for example, ARONIX M-208 manufactured by TOAGOSEI CO., LTD., or the like), 1,6-hexanediol di(meth)acrylate and a epichlorohydrin-modified product thereof, neopentyl glycol di(meth)acrylate, hydroxypivalic acid neopentyl glycol di(meth)acrylate and a caprolactone-modified product thereof, 1,4-butanediol di(meth)acrylate, 1,9-nonanediol di(meth)acrylate, trimethylolpropane di(meth)acrylate, tricyclodecane dimethanol di(meth)acrylate, pentaerythritol di(meth)acrylate monostearate, trimethylolpropane acrylic acid-benzoic acid ester, and isocyanuric acid EO-modified di(meth)acrylate (as a commercial product, for example, ARONIX M-215 manufactured by TOAGOSEI CO., LTD., and the like).

Examples of the (meth)acrylate-based compound not having a urethane bond also include trifunctional (meth)acrylate compounds such as trimethylolpropane tri(meth)acrylate and EO-, PO-, and epichlorohydrin-modified products thereof, pentaerythritol tri(meth)acrylate, glycerol tri(meth)acrylate and EO-, PO-, and epichlorohydrin-modified products thereof, isocyanuric acid EO-modified tri(meth)acrylate (as a commercial product, for example, ARONIX M-315 manufactured by TOAGOSEI CO., LTD., or the like), tris(meth)acryloyloxyethyl phosphate, hydrogen-(2,2,2-tri-(meth)acryloyloxymethyl)ethyl phthalate, and glycerol tri(meth)acrylate and EO-, PO-, and epichlorohydrin-modified products thereof; tetrafunctional (meth)acrylate compounds such as pentaerythritol tetra(meth)acrylate and EO-, PO-, and epichlorohydrin-modified products thereof, and ditrimethylolpropane tetra(meth)acrylate; pentafunctional (meth)acrylate compounds such as dipentaerythritol penta(meth)acrylate and EO-, PO-, epichlorohydrin-, fatty acid-, and alkyl-modified products thereof; and hexafunctional (meth)acrylate compounds such as dipentaerythritol hexa(meth)acrylate and EO-, PO-, epichlorohydrin-, fatty acid-, and alkyl-modified products thereof as well as sorbitol hexa(meth)acrylate and EO-, PO-, epichlorohydrin-, fatty acid-, and alkyl-modified products thereof.

Two or more kinds of second radically polymerizable compounds may be used in combination. In this case, “DPHA” (manufactured by Nippon Kayaku Co., Ltd.) as a mixture of dipentaerythritol pentaacrylate and dipentaerythritol hexaacrylate and the like can be preferably used.

As the (meth)acrylate-based compound, polyester (meth)acrylate and epoxy (meth)acrylate having a weight-average molecular weight equal to or greater than 200 and less than 1,000 are also preferable. Examples thereof include commercially available polyester (meth)acrylate products such as a BEAMSET (trade name) 700 series, that is, BEAMSET 700 (hexafunctional), BEAMSET 710 (tetrafunctional), and BEAMSET 720 (trifunctional) manufactured by Arakawa Chemical Industries, Ltd., and the like. Examples of the epoxy (meth)acrylate include an SP series such as SP-1506, 500, SP-1507, and 480 (trade names) as well as a VR series such as VR-77 manufactured by Showa Highpolymer Co., Ltd., EA-1010/ECA, EA-11020. EA-1025, EA-6310/ECA (trade names) manufactured by SHIN-NAKAMURA CHEMICAL CO., LTD., and the like.

Specific examples of the (meth)acrylate-based compound include the following example compounds A-9 to A-11.

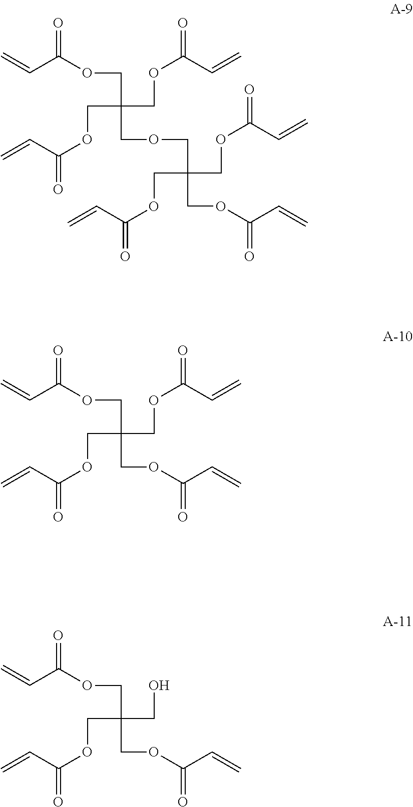

Specific examples of the (meth)acrylate-based compound having three or more (meth)acryloyl groups in a molecule include the example compounds shown in paragraph “0096” in JP2007-256844A and the like.

Specific examples of the (meth)acrylate-based compound having three or more (meth)acryloyl groups include KAYARAD DPHA, KAYARAD DPHA-2C, KAYARAD PET-30, KAYARAD TMPTA, KAYARAD TPA-320, KAYARAD TPA-330, KAYARAD RP-1040, KAYARAD T-1420, KAYARAD D-310, KAYARAD DPCA-20, KAYARAD DPCA-30, KAYARAD DPCA-60, and KAYARAD GPO-303 manufactured by Nippon Kayaku Co., Ltd., and a compound obtained by esterifying a polyol and (meth)acrylic acid, such as V#400 and V#36095D manufactured by OSAKA ORGANIC CHEMICAL INDUSTRY LTD. Furthermore, it is possible to suitably use urethane acrylate compounds having three or more functional groups, such as SHIKOH UV-1400B, SHIKOH UV-1700B, SHIKOH UV-6300B, SHIKOH UV-7550B, SHIKOH UV-7600B, SHIKOH UV-7605B, SHIKOH UV-7610B, SHIKOH UV-7620EA, SHIKOH UV-7630B, SHIKOH UV-7640B, SHIKOH UV-6630B, SHIKOH UV-7000B, SHIKOH UV-7510B, SHIKOH UV-7461TE, SHIKOH UV-3000B, SHIKOH UV-3200B, SHIKOH UV-3210EA, SHIKOH UV-3310EA, SHIKOH UV-3310B, SHIKOH UV-3500BA, SHIKOH UV-3520TL, SHIKOH UV-3700B, SHIKOH UV-6100B, SHIKOH UV-6640B, SHIKOH UV-2000B, SHIKOH UV-2010B, SHIKOH UV-2250EA, and SHIKOH UV-2750B (manufactured by The Nippon Synthetic Chemical Industry Co., Ltd.), UL-503LN (manufactured by KYOEISHA CHEMICAL Co., LTD), UNIDIC 17-806, UNIDIC 17-813, UNIDIC V-4030, and UNIDIC V-4000BA (manufactured by DIC Corporation), EB-1290K, EB-220, EB-5129, EB-1830, and EB-4358 (manufactured by Daicel-UCB Company, Ltd.), HI-COAP AU-2010 and HI-COAP AU-2020 (manufactured by TOKUSHIKI Co., Ltd.), ARONIX M-1960 (manufactured by TOAGOSEI CO., LTD.), ART RESIN UN-3320HA, UN-3320HC, UN-3320HS, UN-904, and HDP-4T, polyester compounds having three or more functional groups such as ARONIX M-8100, M-8030, and M-9050 (manufactured by TOAGOSEI CO., LTD.) and KBM-8307 (manufactured by Daicel SciTech), and the like.

In the present invention, the (meth)acrylate-based compound contained in the second cured layer may be constituted with a single compound, or a plurality of compounds can be used in combination as the (meth)acrylate-based compound.

The content of the cured substance of the (meth)acrylate-based compound with respect to the total mass of the second cured layer is preferably 30% to 99% by mass, more preferably 60% to 99% by mass, and even more preferably 90% to 99% by mass.

(Inorganic Particles)

The cured layer of the hardcoat film of the present invention may contain inorganic particles. The inorganic particles are not particularly limited, and for example, fine particles formed of silica, alumina, zirconia, titanium, and the like can be used.

In the hardcoat film of the present invention, the content of the inorganic particles in the second cured layer is preferably equal to or smaller than 10% by mass. The content of the inorganic particles in the second cured layer is more preferably equal to or smaller than 5% by mass, and even more preferably equal to or smaller than 3% by mass.

Generally, inorganic particles exhibit low affinity with an organic component. Therefore, in a case where the cured layer contains the inorganic particles, sometimes the cured layer having undergone curing easily cracks. In a case where the content of the inorganic particles in the second cured layer is equal to or smaller than 10% by mass, it is possible to prevent the first cured layer from cracking at the time of punching process.

(Other Materials)

If necessary, each of the first and second cured layers can contain an antifoulant, a surface conditioner, a leveling agent, and the like. The content of these may be appropriately adjusted and is not particularly limited.

<Content Rate of Cured Substance of Epoxy-Based Compound in First and Second Cured Layers>

Although the second cured layer may or may not contain the cured substance of the epoxy-based compound, the content (content rate (W2)) of the cured substance of the epoxy-based compound in the second cured layer with respect to the total mass of the second cured layer is smaller than the content (content rate (W1)) of the cured substance of the epoxy-based compound in the first cured layer with respect to the total mass of the first cured layer.

In the present invention, the content rate (W1) is preferably 10% to 70% by mass, and more preferably 25% to 70% by mass.

The content rate (W2) is preferably equal to or lower than 15% by mass, more preferably equal to or lower than 10% by mass, and even more preferably equal to or lower than 5% by mass.

<Film Thickness of First and Second Cured Layers>

A ratio of a film thickness (T1) of the first cured layer to a film thickness (T2) of the second cured layer satisfies the following Expression (1).

7>(film thickness (T1) of first cured layer/film thickness (T2) of second cured layer)>1 Expression (1):

In the present invention, from the viewpoint of improving cutting properties, Expression (1) preferably satisfies the following expression (1-1), more preferably satisfies the following Expression (1-2), and even more preferably satisfies the following Expression (1-3).

6>(T1/T2)>1.5 Expression (1-1):

4>(T1/T2)>2 Expression (1-2):

3>(T1/T2)>2 Expression (1-3):

Furthermore, regarding the film thickness of each of the cured layers, the film thickness (T1) of the first cured layer is preferably 10 to 60 μm, more preferably 15 to 40 μm, and even more preferably 15 to 30 μm.

The film thickness (T2) of the second cured layer is preferably 5 to 30 μm, more preferably 5 to 20 μm, and even more preferably 10 to 15 μm.

As described above, by making the content rate of the cured substance of the epoxy-based compound in the second cured layer lower than the content rate of the cured substance of the epoxy-based compound in the first cured layer, the film thickness of the second cured layer can be smaller than the film thickness of the first cured layer. As a result, the total thickness of the film can be reduced, and the distortion of the obtained film can be prevented. Therefore, a hardcoat film having excellent cutting properties can be obtained.

The hardcoat film of the present invention may have other cured layers in addition to the first cured layer and the second cured layer. In order for the hardcoat film of the present invention to have excellent cutting properties, it is preferable that among a plurality of cured layers, the first cured layer and the second cured layer are formed on both surface sides of a support as main layers.

In a case where the hardcoat film of the present invention is used in a touch panel, it is preferable that the hardcoat film is disposed such that the first cured layer becomes a touch surface side. In order for the film to exhibit excellent surface smoothness, it is preferable that the first cured layer satisfying the aforementioned condition is disposed on the uppermost surface side of the film.

(Method for Forming Cured Layer)

The first and second cured layers can be prepared by mixing together various components constituting each of the cured layers at the same time or by sequentially mixing together the components in any order. The preparation method is not particularly limited, and a known stirrer and the like can be used for preparation.

By coating a support with the composition for forming a cured layer prepared as above directly or through another layer such as an adhesive layer or a pressure sensitive adhesive layer and irradiating the composition with light, a cured layer can be formed. The coating may be performed by known coating methods such as a dip coating method, an air knife coating method, a curtain coating method, a roller coating method, a die coating method, a wire bar coating method, and a gravure coating method. The amount of the composition used for coating may be adjusted such that a cured layer having a desired film thickness can be formed. The cured layer can also be formed as a cured layer having a laminated structure including two or more layers (for example, about two to five layers) by simultaneously or sequentially coating a support with two or more kinds of compositions having different makeups.

If necessary, a drying treatment may be performed before or after the light irradiation or before and after the light irradiation. The drying treatment can be performed by hot air blowing, disposing the support with the composition in a heating furnace, or transporting the support with the composition in a heating furnace, and the like. The heating temperature may be set to be a temperature at which a solvent can be dried and removed, and is not particularly limited. Herein, the heating temperature refers to the temperature of hot air or the internal atmospheric temperature of the heating furnace.

(Other Materials)

The cured layer or the active energy ray-curable resin composition can additionally contain a polymerizable compound, a photopolymerization initiator, an antifoulant, a solvent, and the like. If necessary, the active energy ray-curable resin composition can optionally contain one or more kinds of known additives. Examples of such additives include a surface conditioner, a leveling agent, a polymerization inhibitor, and the like. For details of these additives, for example, paragraphs “0032” to “0034” in JP2012-229412A can be referred to. However, the present invention is not limited thereto, and it is possible to use various types of additives that are generally used in photopolymerizable compositions. The amount of the additives added to the active energy ray-curable resin composition may be appropriately adjusted and is not particularly limited.

<<Antifoulant>>

It is preferable that the cured layer or the active energy ray-curable resin composition contains an antifoulant, because then the adhesion of finger print or contaminant is suppressed, the contaminant that has adhered can be wiped off in a simple way, and scratch resistance can be improved by enhancing sliding properties of the surface of the cured layer. The antifoulant will be referred to as g) component as well.

The antifoulant preferably contains a fluorine-containing compound, the fluorine-containing compound preferably has a perfluoropolyether group and polymerizable unsaturated groups, and the antifoulant has a plurality of polymerizable unsaturated groups in one molecule.

As the antifoulant usable in the present invention, it is possible to use the materials described in paragraphs “0012” to “1101” in JP2012-088699A. and the content of the publication is incorporated into the present specification.

As the antifoulant described so far, those synthesized by known methods or commercial products may be used. As the commercial products, RS-90, RS-78, and TF1682 manufactured by DIC Corporation and the like can be preferably used. From the viewpoint of scratch resistance, RS-90 manufactured by DIC Corporation can be more preferably used.

(Optional Layer)

The hardcoat film of the present invention may optionally include one or more other layers, in addition to the support and the first and second cured layers. Examples of the optional layers include, but are not limited to, an easy-adhesive layer, an antireflection layer (laminated film consisting of one or more layers of high refractive index and one or more layers of low refractive index), and the like. Regarding these layers, for example, paragraphs “0069” to “0091” in JP5048304B and the like can be referred to. Furthermore, a touch sensor film, a polarizer, a decorative layer may also be provided.

(Layer of Low Refractive Index)

In a case where the hardcoat film of the present invention is used as an antireflection film, an aspect is also preferable in which a single or a plurality of antireflection layers are laminated on the surface of the cured layer. The constitution of an antireflection layer which can be preferably used in the present invention will be shown below.

A: support/cured layer/layer of low refractive index

B: support/cured layer/layer of high refractive index/layer of low refractive index

C: support/cured layer/layer of medium refractive index/layer of high refractive index/layer of low refractive index

In the hardcoat film of the present invention, it is preferable that a layer of low refractive index is disposed on the cured layer directly or through another layer.

Paragraphs “0077” to “0102” in JP2009-204725A describe preferred aspects of the layer of low refractive index, and the content of the publication is incorporated into the present invention.

In the hardcoat film of the present invention, by providing a layer having a high refractive index (layer of high refractive index or a layer of medium refractive index) between the layer of low refractive index and the cured layer, antireflection properties can be improved. The layer of high refractive index and the layer of medium refractive index are collectively called a layer of high refractive index in some cases. “High”, “medium”, and “low” for the layer of high refractive index, the layer of medium refractive index, and the layer of low refractive index show the relationship between the layers based on the relative magnitude of the refractive index thereof. Furthermore, regarding the relationship with the support based on the refractive index, it is preferable that a relationship of support >layer of low refractive index and a relationship of layer of high refractive index >support are satisfied.

In the present specification, the layer of high refractive index, the layer of medium refractive index, and the layer of low refractive index are collectively called an antireflection layer in some cases. Paragraphs “0103” to “0112” in JP2009-204725A describe preferred aspects of the layer of high refractive index, and the content of the publication is incorporated into the present specification.

(Touch Sensor Film)

It is preferable that a touch sensor film is bonded to one surface of the hardcoat film of the present invention, preferably to a surface opposite to the surface on which the second cured layer is disposed.

The touch sensor film is not particularly limited, but is preferably a conductive film in which a conductive layer is formed.

The conductive film preferably includes any support and a conductive layer disposed on the support.

The material of the conductive layer is not particularly limited, and examples thereof include an indium-tin composite oxide (Indium Tin Oxide; ITO), tin oxide, antimony tin oxide (ATO); copper, silver, aluminum, nickel, chromium, an alloy of these, and the like.

The conductive layer is preferably an electrode pattern. Furthermore, the conductive layer is also preferably a transparent electrode pattern. The electrode pattern may be obtained by forming a layer of a transparent conductive material by patterning or obtained by forming a layer of a non-transparent conductive material by patterning.

As the transparent conductive material, it is possible to use an oxide such as ITO or ATO, silver nanowires, carbon nanotubes, a conductive polymer, and the like.

Examples of the layer of a non-transparent conductive material include a metal layer. As the metal layer, any metal having conductivity can be used, and silver, copper, gold, aluminum, and the like are suitably used. The metal layer may be a simple metal or an alloy, or may be a layer in which metal particles are bonded to each other through a binder. If necessary, the surface of the metal may be subjected to a blackening treatment or a rust-proofing treatment. In a case where a metal is used, a sensor portion that is substantially transparent and a peripheral wiring portion can be collectively formed.

It is preferable that the conductive layer contains a plurality of metal thin wires.

The metal thin wires are preferably formed of silver or an alloy containing silver. The conductive layer containing metal thin wires formed of silver or an alloy containing silver is not particularly limited, and known conductive layers can be used. For example, it is preferable to use the conductive layer described in paragraphs “0040” and “0041” in JP2014-168886A, and the content of the publication is incorporated into the present specification.

It is also preferable that the metal thin wires are formed of copper or an alloy containing copper. The conductive layer containing metal thin wires formed of copper or an alloy containing copper is not particularly limited, and known conductive layers can be used. For example, it is preferable to use the conductive layer described in paragraphs “0038” to “0059” in JP2015-49852A, and the content of the publication is incorporated into the present specification.

It is also preferable that the conductive layer is formed of an oxide. In a case where the conductive layer is formed of an oxide, it is more preferable that the oxide is formed of indium oxide containing tin oxide or of tin oxide containing antimony. The conductive layer formed of an oxide is not particularly limited, and known conductive layers can be used. For example, it is preferable to use the conductive layer described in paragraphs “0017” to “0037” in JP2010-27293A, and the content of the publication is incorporated into the present specification.

Among these conductive layer constituted as above, a conductive layer is preferable which contains a plurality of metal thin wires that are disposed in a mesh shape or a random shape, and a conductive layer is more preferable in which the metal thin wires are disposed in a mesh shape. Particularly, a conductive layer is preferable in which the metal thin wires are disposed in a mesh shape and formed of a silver or an alloy containing silver.

It is also preferable that the touch sensor film has a conductive layer on both surfaces thereof.

Paragraphs “0016” to “0042” in JP2012-206307A describe preferred aspects of the touch sensor film, and the content of the publication is incorporated into the present invention.

(Polarizer)

It is preferable a polarizer is bonded to one surface of the hardcoat film of the present invention.

The hardcoat film of the present invention is used on one side or both sides of a protect film of a polarizing plate including a polarizer and a protect film disposed on both sides of the polarizer, and in this way, a polarizing plate having hardcoat properties can be obtained.

It is preferable to be able to provide a polarizing plate which has the hardcoat film of the present invention, has ameliorated brittleness, is excellent in handleability, does not impair display quality by surface smoothness or wrinkles, and can suppress the leakage of light at the time of moist-heat test.

The hardcoat film of the present invention may be used as a protect film for one side, and a general cellulose acetate film may be used as a protect film for the other side. As the protect film for the other side, it is preferable to use a cellulose acetate film which is manufactured by a solution film forming method and stretched along a width direction in a roll film form at a stretching ratio of 10% to 100%.

An aspect is also preferable in which, of the two sheets of the protect films of the polarizer, the film other than the hardcoat film of the present invention is an optical compensation film having an optical compensation layer including an optically anisotropic layer. The optical compensation film (phase difference film) can improve the viewing angle characteristics of a liquid crystal display screen. As the optical compensation film, known optical compensation films can be used, but in view of widening the viewing angle, the optical compensation film described in JP2001-100042A is preferable.

The polarizer includes an iodine-based polarizer, a dye-based polarizer using a dichroic dye, and a polyene-based polarizer. The iodine-based polarizer and the dye-based polarizer are generally manufactured using a polyvinyl alcohol-based film.

As the polarizer, a known polarizer or a polarizer cut out from a long polarizer whose absorption axis is neither parallel nor perpendicular to the longitudinal direction may be used. The long polarizer whose absorption axis is neither parallel nor perpendicular to the longitudinal direction is prepared by the following method.

That is, the polarizer can be manufactured by a stretching method in which, in a state where both ends of a continuously supplied polymer film such as a polyvinyl alcohol-based film are being held by holding means, the film is stretched under a tension applied thereto such that the film is stretched 110% to 2,000% in at least the film width direction; a difference in a moving rate between the holding devices at both ends of the film in the longitudinal direction is made within 3%; and the moving direction of the film is bent in a state where both ends of the film are being held, such that the moving direction of the film at the exit of the step of holding both ends of the film and the actual stretching direction of the film form an oblique angle of 20° to 70°. From the viewpoint of productivity, a polarizer in which an oblique angle of 45° is formed is preferably used.

The stretching method of the polymer film is specifically described in paragraphs “0020” to “0030” in JP2002-86554A.

<Articles Including Hardcoat Film>

Examples of articles including the hardcoat film of the present invention include various articles required to be improved in terms of scratch resistance in various industrial fields such as the field of home appliances, the field of electricity and electronics, the field of automobiles, and the field of housing. Specifically, examples of such articles include a touch sensor, a touch panel, an image display such as a liquid crystal display, window glass of automobiles, window glass for home, and the like. By providing the hardcoat film of the present invention preferably as a surface protect film in these articles, it is possible to provide articles having excellent scratch resistance. It is preferable that the hardcoat film of the present invention is a hardcoat film for front plate of a touch panel.

[Front Plate of Image Display Element]

The front plate of an image display element of the present invention is a front plate of an image display element containing the hardcoat film of the present invention. As described above, in a case where the hardcoat film of the present invention is provided as a surface protect film of an image display, the hardcoat film of the present invention can be used as a front plate of an image display element. Furthermore, in a case where the hardcoat film is provided as a cover plastic as a substitute for cover glass that has been used in the related art as a front plate of a touch panel, the hardcoat film of the present invention can also be used as front plate of an image display element.

The touch panel in which the front plate of an image display element of the present invention can be used is not particularly limited, and can be appropriately selected according to the purpose. Examples of the touch panel include a surface capacitance-type touch panel, a projected capacitance-type touch panel, a resistive film-type touch panel, and the like. Details of the touch panel will be specifically described later by using the resistive film-type touch panel and the capacitance-type touch panel of the present invention.

The touch panel includes so-called touch sensor and touch pad. In the touch panel, the layer constitution of a touch panel sensor electrode portion may be established by any of a bonding method in which two sheets of transparent electrodes are bonded to each other, a method of providing a transparent electrode on both surfaces of one sheet of substrate, a method using a single-face jumper or a through hole, and a single-face lamination method. Furthermore, for the projected capacitance-type touch panel, alternating current (AC) driving is more preferred than direct current (DC) driving, and a driving method in which voltage is applied to the electrode for a short period of time is more preferable.

[Resistive Film-Type Touch Panel]

The resistive film-type touch panel of the present invention includes the front plate of an image display element of the present invention.

Basically, the resistive film-type touch panel has a constitution in which conductive films of a pair of upper and lower substrates each having a conductive film are disposed with a spacer therebetween such that the conductive films face each other. The constitution of the resistive film-type touch panel is known, and in the present invention, known techniques can be adopted without any limitation.

[Capacitance-Type Touch Panel]

The capacitance-type touch panel of the present invention includes the front plate of an image display element of the present invention.

Examples of the capacitance-type touch panel include a surface capacitance-type touch panel, a projected capacitance-type touch panel, and the like. Basically, the projected capacitance-type touch panel has a constitution in which an X-axis electrode and a Y-axis electrode orthogonal to the X-electrode are disposed with an insulating material therebetween. Examples of specific aspects thereof include an aspect in which an X-electrode and a Y-electrode are formed on different surfaces of one sheet of substrate, an aspect in which an X-electrode, a layer of an insulating material, and a Y-electrode are formed in this order on one sheet of substrate, an aspect in which an X-electrode is formed on one sheet of substrate while a Y-electrode is formed on the other substrate (in this aspect, a constitution in which two sheets of substrates are bonded to each other is adopted as the aforementioned basic constitution), and the like. The constitution of the capacitance-type touch panel is known, and in the present invention, known techniques can be adopted without any limitation.

[Image Display]

The image display of the present invention includes the front plate of the image display element and the image display element of the present invention.

The front plate of an image display element of the present invention can be used in image displays such as a liquid crystal display (LCD), a plasma display panel, an electroluminescence display, and a cathode tube display. Examples of the liquid crystal display include a twisted nematic (TN) type, a super-twisted nematic (STN) type, a triple super twisted nematic (TSTN) type, a multi domain type, a vertical alignment (VA) type, an in-plane switching (IPS) type, an optically compensated bend (OCB) type, and the like.

According to the present invention, it is preferable to be able to provide an image display which has the front plate of an image display element of the present invention, has ameliorated brittleness, is excellent in handleability, does not impair display quality by surface smoothness or wrinkles, and can suppress the leakage of light at the time of moist-heat test.

The image display is particularly preferably a liquid crystal display including a liquid crystal cell and the polarizing plate of the present invention disposed on at least one surface of the liquid crystal cell, in which the hardcoat film of the present invention is disposed on the uppermost surface of the liquid crystal display. That is, in the image display of the present invention, the image display element is preferably a liquid crystal display element.

In the image display of the present invention, the image display element is also preferably an organic electroluminescence display element.

In the image display of the present invention, the image display element is preferably an in-cell touch panel display element. The in-cell touch panel display element is an element in which a touch panel function is included in a cell of an image display element.

In the in-cell touch panel liquid crystal element, for example, the known techniques described in JP2011-76602A, JP2011-222009A, and the like can be adopted without any limitation.

Furthermore, in the image display of the present invention, the image display element is also preferably an on-cell touch panel display element. The on-cell touch panel display element is an element in which a touch panel function is on the outside of a cell of an image display element.

In the on-cell touch panel liquid crystal element, for example, the known techniques described in JP2012-88683A and the like can be adopted without any limitation.

### EXAMPLES

Hereinafter, the present invention will be more specifically described based on examples. The materials, the reagents, the amount of substances and the proportion of the substances, the operation, and the like shown in the following examples can be appropriately changed within a scope that does not depart from the gist of the present invention. Accordingly, the scope of the present invention is not limited to the following specific examples. In the following examples, unless otherwise specified, “%” means “% by mass”, and a mixing ratio means a mass ratio. Furthermore, unless otherwise specified, the steps in the following examples are performed at room temperature. The room temperature is a temperature within a range of 20° C. to 25° C.

### Preparation of Support

### Examples 1 to 16 and 19 and Comparative Example 1 to 4

<Preparation of Resin Film>

Pellets of an acrylic resin (PMMA) (trade name: SUMIPEX EX) manufactured by Sumitomo Chemical Co., Ltd were put into a single-screw extruder having an extrusion diameter of 65 mmφ, and a polycarbonate-based resin (PC) (trade name: CALIBRE 301-10) manufactured by Sumika Styron Polycarbonate Limited was put into a single-screw extruder having an extrusion diameter of 45 mmφ. The resins were melted, and integrated by being melted and laminated by a multi-manifold method. Then, each layer was controlled such that the film thickness thereof became as shown in Table 2, and the resin was extruded through T-shaped dies at a set temperature of 260° C. The obtained film-shaped substance was molded by being sandwiched between a pair of metal rolls, thereby preparing a resin film constituted with three layers of acrylic resin film/polycarbonate resin film/acrylic resin film.

### Example 17

<Preparation of Resin Film>

A cellulose acylate (tack) film (laminated film) constituted with three layers (outer layer/core layer/outer layer) was prepared by the following method.

((1) Preparation of Cellulose Acylate Dope for Core Layer)

The following composition was put into a mixing tank and stirred, and the components were dissolved, thereby preparing a cellulose acylate dope for a core layer.

(Cellulose acylate dope for core layer)

| | | |
|---|---|---|
| Cellulose acetate with a degree of acetyl | 100 | parts by mass |
| substitution of 2.88 and a weight-average | | |
| molecular weight of 260,000 | | |
| Phthalic acid ester oligomer A having | 10 | parts by mass |
| the following structure | | |
| Compound represented by Formula I | 4 | parts by mass |
| Ultraviolet absorber (compound represented | 2.7 | parts by mass |
| by Formula II, manufactured by BASF SE) | | |
| Light stabilizer (TINUVIN 123 manufactured | 0.18 | parts by mass |
| by BASF SE) | | |
| N-alkenylpropylenediamine tetraacetic acid | 0.02 | parts by mass |
| (TEKURAN DO manufactured by Nagase | | |
| ChemteX Corporation) | | |
| Methylene chloride (first solvent) | 430 | parts by mass |
| Methanol (second solvent) | 64 | parts by mass |

The used compounds will be shown below.
Phthalic acid ester oligomer A (weight-average molecular weight: 750)

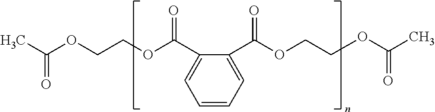

Compound represented by Formula I

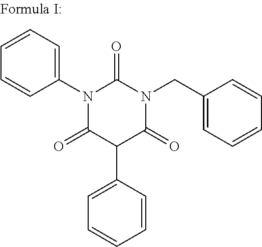 [SMILES: O=C1C(c2ccccc2)C(=O)N(c2ccccc2)C(=O)N1Cc1ccccc1]

Compound represented by Formula II (Ultraviolet absorber)

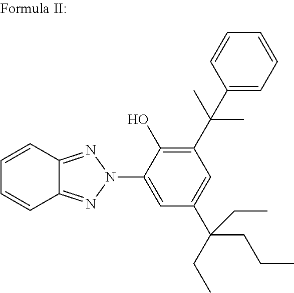 [SMILES: CCCC(CC)(CC)c1cc(-n2nc3ccccc3n2)c(O)c(C(C)(C)c2ccccc2)c1]

((2) Preparation of Cellulose Acylate Dope for Outer Layer)

10 parts by mass of a composition containing inorganic particles shown below was added to 90 parts by mass of the aforementioned cellulose acylate dope for a core layer, thereby preparing a cellulose acylate dope solution for an outer layer.

(Composition containing inorganic particles)

| | | |
|---|---|---|
| Silica particles having average primary particle | 2 | parts by mass |
| diameter of 20 nm (AEROSIL R972manufactured | | |
| by NIPPON AEROSIL CO., LTD) | | |
| Methylene chloride (first solvent) | 76 | parts by mass |
| Methanol (second solvent) | 11 | parts by mass |
| Cellulose acylate dope for core layer | 1 | part by mass |

((3) Preparation of Resin Film)

The cellulose acylate dope for a core layer and the cellulose acylate dope solution for an outer layer to be cast to both sides of the cellulose acylate dope for a core layer were simultaneously cast onto a drum having a surface temperature of 20° C. from a casting outlet. In a state where the content rate of the solvent was about 20% by mass, the film was peeled off. Then, both ends of the film in the width direction were fixed to tenter clips, and in a state where the amount of the residual solvent became 3% to 15% by mass, the film was dried while being stretched 118% in the width direction. Thereafter, the film was transported between rolls of a heat treatment device and then further dried, thereby preparing a resin film having a thickness of 200 μm.

### Example 18

<Preparation of Resin Film>

((1) Preparation of Composition for Forming Easy-Adhesive Layer)

Polymerizable compounds composed as below were copolymerized, thereby obtaining a sulfonic acid-based aqueous dispersion of a polyester-based resin.

(Acid components) terephthalic acid/isophthalic acid/sodium 5-sulfoisophthalate//(diol components) ethylene glycol/diethylene glycol=44/46/10/84/16 (molar ratio)

Then, a cross-linking agent (isocyanate-based compound A) was prepared in the following sequence.

A nitrogen atmosphere was created in a four-neck flask (reactor) equipped with a stirrer, a thermometer, a reflux condenser, and a nitrogen introduction pipe, and the reactor was filled with 1,000 parts by mass of hexamethylene diisocyanate (HDI) and 22 parts by mass of trimethylolpropane (molecular weight: 134) as a trihydric alcohol. Then, urethanization was performed by keeping the temperature of the reaction solution in the reactor at 90° C. for 1 hour with stirring. The temperature of the reaction solution was then kept at 60° C. and trimethylbenzyl ammonium-hydroxide as an isocyanurating catalyst was added thereto. At a point time when the conversion rate reached 48%, phosphoric acid was added so as to stop the reaction. Thereafter, the reaction solution was filtered, and then unreacted HDI was removed using a thin film evaporator.

In the obtained isocyanate-based compound a, a viscosity at 25° C. was 25,000 mPa·s, a content of isocyanate groups was 19.9% by mass, a number average molecular weight was 1,080, and the average number of isocyanate groups was 5.1. The number average molecular weight which is mentioned above and will be mentioned below is a number average molecular weight measured by GPC and expressed in terms of polystyrene. Thereafter, by nuclear magnetic resonance (NMR) spectroscopy, whether a urethane bond, an allophanate bond, and an isocyanurate bond exist was checked.

A nitrogen atmosphere was created in a four-neck flask (reactor) equipped with a stirrer, a thermometer, a reflux condenser, a nitrogen introduction pipe, and a dropping funnel, and the reactor was filled with 100 parts by mass of the isocyanate-based compound obtained as above, 42.3 parts by mass of methoxypolyethylen glycol having a number average molecular weight of 400, and 76.6 parts by mass of dipropylene glycol dimethyl ether. The temperature of the reaction solution was kept at 80° C. for 6 hours. Then, the reaction solution was cooled to 60° C., 72 parts by mass of diethyl malonate and 0.88 parts by mass of a methanol solution with 28% sodium methylate were added thereto, and the reaction solution was kept as it was for 4 hours. Thereafter, 0.86 parts by mass of 2-ethylhexyl acid phosphate was added thereto. Subsequently, 43.3 parts by mass of diisopropylamine was added thereto, and the reaction solution was kept at 70° C. for 5 hours. By analyzing the reaction solution by gas chromatography, it was confirmed that the reaction rate of diisopropylamine was 70%. In this way, an isocyanate-based compound A was obtained (concentration of solid content: 70% by mass, mass of effective NCO group: 5.3%).

57.6 parts by mass of a carboxylic acid-modified polyvinyl alcohol resin (manufactured by KURARAY CO., LTD.) having a degree of saponification of 77% and a degree of polymerization of 600, 28.8 parts by mass (solid content) of the polyester-based resin prepared as above, 4.0 parts by mass of the isocyanate-based compound A prepared as above, 0.7 parts by mass of an organic tin-based compound (ELASTRON Cat⋅21 manufactured by DKS Co., Ltd.), and 8.1 parts by mass of silica sol having an average primary particle diameter of 80 nm were mixed together and diluted with water such that the solid content thereof became 8.9 parts by mass, thereby preparing a composition for forming an easy-adhesive layer.

((2) Preparation of Resin Film)

<Synthesis of Raw Material Polyester>

(Raw Material Polyester 1)

Terephthalic acid and ethylene glycol were directly reacted with each other as shown below, water was distilled away, and esterification was performed. Then, by using a direct esterification method in which polycondensation is performed under reduced pressure, a raw material polyester 1 (Sb catalyst-based PET) was obtained using a continuous polymerization device.

(1) Esterification Reaction

In a first esterification reactor, 4.7 tons of high-purity terephthalic acid and 1.8 tons of ethylene glycol were mixed together for 90 minutes, thereby forming a slurry. The slurry was continuously supplied to the first esterification reactor at a flow rate of 3,800 kg/h. Furthermore, antimony trioxide in an ethylene glycol solution was continuously supplied thereto, and a reaction was performed with stirring at an internal temperature of the reactor of 250° C. and an average residence time of about 4.3 hours. At this time, the antimony trioxide was continuously added such that the amount of Sb added became 150 ppm in terms of the element.

The reactant was moved to a second esterification reactor and reacted with stirring at an internal temperature of the reactor of 250° C. and an average residence time of 1.2 hours. To the second esterification reactor, magnesium acetate in an ethylene glycol solution and trimethyl phosphate in an ethylene glycol solution were continuously supplied such that the amount of Mg added and the amount of P added became 65 ppm and 35 ppm respectively in terms of the elements.

(2) Polycondensation Reaction

The esterification reaction product obtained as above was continuously supplied to a first polycondensation reactor and subjected to polycondensation with stirring at a reaction temperature of 270° C., an internal pressure of the reactor of 20 torr (2.67×10⁻⁴ MPa), and an average residence time of about 1.8 hours.

The product was moved to a second polycondensation reactor and reacted (polycondensed) in the reactor under the condition of an internal temperature of the reactor of 276° C., an internal pressure of the reactor of 5 torr (6.67×10⁻⁴ MPa), and a residence time of about 1.2 hours.

Then, the product was moved to a third polycondensation reactor. In this reactor, the product was reacted (polycondensed) under the condition of an internal temperature of the reactor of 278° C., an internal pressure of the reactor of 1.5 torr (2.0×10⁻⁴ MPa), and a residence time of 1.5 hours, thereby obtaining a reactant (polyethylene terephthalate (PET)).

Thereafter, the obtained reactant was jetted to cold water in the form of strands and immediately cut, thereby preparing polyester pellets <cross-section: major axis of about 4 mm, minor axis of about 2 mm, and length of about 3 mm>.

IV of the obtained polymer was 0.63. The polymer was named a raw material polyester 1.

(Raw Material Polyester 2)

10 parts by mass of a dried ultraviolet absorber (2,2′-(1,4-phenylene)bis(4H-3,1-benzoxazin-4-one) and 90 parts by mass of the raw material polyester 1 (IV=0.63) were mixed together and made into pellets in the same manner as in Preparation of raw material polyester 1 by using a kneading extruder, thereby obtaining a raw material polyester 2 containing an ultraviolet absorber.

A polyester-based resin film (laminated film) constituted with three layers (layer I/layer II/layer III) was prepared by the following method.

A composition for the layer II was dried until the moisture content thereof became equal to or lower than 20 ppm (based on mass), put into a hopper of a single-screw kneading extruder having a diameter of 50 mm and melted at 300° C. in the extruder, thereby preparing a molten resin material for forming the layer II positioned between the layer I and the layer II.

(Composition for layer II)

| | |
|---|---|
| Raw material polyester 1 | 90 parts by mass |
| Raw material polyester 2 containing 10 parts by mass | 10 parts by mass |
| of ultraviolet absorber (2,2′-(1,4-phenylene)bis(4H- | |
| 3,1-benzoxazin-4-one)) | |

The raw material polyester 1 was dried until the moisture content thereof became equal to or lower than 20 ppm (based on mass), put into a hopper of a single-screw kneading extruder having a diameter of 30 mm, and melted at 300° C. in the extruder, thereby preparing a molten resin material for forming the layer I and the layer III.

These two kinds of molten resin materials were respectively passed through a gear pump and a filter (pore size: 20 μm). Then, through a block by which the two kinds of resins become confluent as three layers, the resin materials were laminated such that the molten resin material extruded from the extruder for the layer II became the inner layer and that the molten resin material extruded from the extruder for the layer I and the layer III became the outer layers, and then extruded in the form of a sheet from a die having a width of 120 mm.

The molten resin sheet extruded from the die was extruded onto a cooling cast drum set to have a surface temperature of 25° C. and caused to come into close contact with the cooling cast drum by using a method of applying static electricity. By using a peeling roll disposed to face the cooling cast drum, the resin sheet was peeled, thereby obtaining a non-stretched film. At this time, the amount of resin jetted from each extruder was adjusted such that a thickness ratio of layer I:layer II:layer III became 10:80:10.

By using a group of heated rolls and an infrared heater, the non-stretched film was heated such that the surface temperature of the film became 95° C. Then, by using a group of rolls having different circumferential speeds, the film was stretched 400% in a direction perpendicular to the movement direction of the film, thereby obtaining a resin film (laminated film) having a thickness of 200 μm.

((3) Preparation of Resin Film with Easy-Adhesive Layer)

One surface of the resin film prepared as above was subjected to a corona discharge treatment at a throughput of 500 J/m². Then, the surface having undergone the corona discharge treatment was coated with the composition for forming an easy-adhesive layer by a reverse roll method with adjusting the amount of the composition such that the thickness became 0.1 μm after drying. In this way, a resin film with an easy-adhesive layer was prepared.

[Preparation of Hardcoat Film]

<Preparation of Composition for Forming Cured Layer>

Components were added according to the composition shown in the following Table 1 and filtered through a filter made of polypropylene having a pore size of 10 μm, thereby preparing compositions HC1 to HC7 for forming a cured layer. For the components excluding a solvent, the numerical values shown in the following Table 1 show “proportion (% by mass) of each component in the total amount of the solid content in the composition for forming a cured layer”. That is, the material such as inorganic particles (ELCOM V-8802 manufactured by JGC C&C) diluted with a solvent was added by adjusting the amount such that the proportion of the solid content became the amount shown in Table 1. For the solvent, the amount thereof was adjusted such that the proportion of the solvent became the proportion described in Table 1. In this way, a composition for forming a cured layer in which a proportion of a solid content was 60% by mass was prepared.

TABLE 1

| Composition for forming cured layer | | HC1 | HC2 | HC3 | HC4 | HC5 | HC6 | HC7 |
|---|---|---|---|---|---|---|---|---|
| Polymerizable | DPHA manufactured by Nippon Kayaku Co., | 64.0% | 64.0% | 95.0% | 80.0% | 69.0% | | |
| compound | Ltd. | | | | | | | |
| | UV-1700B manufactured by The Nippon | | | | | | 64.0% | 80.0% |
| | Synthetic Chemical Industry Co., Ltd. | | | | | | | |
| | DENACOL EX-314 manufactured by Nagase | 15.0% | | | | | | |
| | ChemteX Corporation | | | | | | | |
| | CYCLOMER M-100 manufactured by | | 15.0% | | | 10.0% | 15.0% | |
| | DAICEL CORPORATION | | | | | | | |
| Inorganic particles | ELCOM V-8802 manufactured by JGC C&C | 15.0% | 15.0% | | 15.0% | 15.0% | 15.0% | 15.0% |
| Photopolymerization | Irg184 manufactured by BASF SE | 4.0% | 4.0% | 4.0% | 4.0% | 4.0% | 4.0% | 4.0% |
| initiator | Cationic photopolymerization initiator PAG-1 | 1.0% | 1.0% | | | 1.0% | 1.0% | |
| Antifoulant | RS-90 manufactured by DIC Corporation | 1.0% | 1.0% | | | | | |
| | TF1682 manufactured by DIC Corporation | | | 1.0% | 1.0% | 1.0% | 1.0% | 1.0% |
| Solvent | Methyl ethyl ketone | 40% | 40% | 40% | 40% | 40% | 40% | 40% |
| | Methyl isobutyl ketone | 60% | 60% | 60% | 60% | 60% | 60% | 60% |

The compounds used are as below.

(Polymerizable compounds)

DPHA manufactured by Nippon Kayaku Co., Ltd.: mixture of dipentaerythritol pentaacrylate and dipentaerythritol hexaacrylate

UV-1700B manufactured by The Nippon Synthetic Chemical Industry Co., Ltd.: decafunctional urethane acrylate monomer

DENACOL EX-314 manufactured by Nagase ChemteX Corporation: glycerol polyglycidyl ether

CYCLOMER M-100 manufactured by DAICEL CORPORATION: 3,4-epoxycyclohexylmethyl methacrylate

(Inorganic particles)

ELCOM V-8802 manufactured by JGC C&C

(Photopolymerization initiators)

IRG 184 (IRGACURE 184, radical photopolymerization initiator based on 1-hydroxy-cyclohexyl-phenyl-ketone, α-hydroxyalkylphenone, manufactured by BASF SE)

PAG-1 (iodonium salt compound shown below (cationic photopolymerization initiator))

Cationic photopolymerization initiator (iodonium salt compound) PAG-1

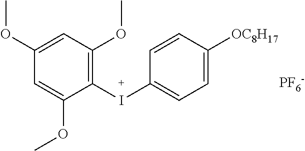

(Antifoulant)

RS-90 manufactured by DIC Corporation

TF1682 manufactured by DIC Corporation

<Formation of Hardcoat Film>

By using any of the compositions HC1 to HC7 for forming a cured layer shown in the following Table 2, the first cured layer and the second cured layer were formed by the method described below, thereby forming hardcoat films of Examples 1 to 19 and Comparative Examples 1 to 4.

<<Formation of First Cured Layer>>

The thickness (total thickness) of the composition for forming a cured layer is adjusted such that it became the thickness shown in the following Table 2 after curing, one surface of the support shown in the following Table 2 was coated with each of the compositions for forming a cured layer, and the composition was cured, thereby forming the first cured layer. In the resin film having the easy-adhesive layer, the surface of the easy-adhesive layer was coated with the composition for forming a cured layer.

Specifically, coating and curing were performed by the following method. By a die coating method using a slot die described in Example 1 in JP2006-122889A, coating was performed using each of the active energy ray-curable compositions under the condition of a transport speed of 30 m/min, and the composition was dried for 150 seconds at an atmospheric temperature of 60° C. Then, with nitrogen purging at an oxygen concentration of about 0.1% by volume, by using an air-cooled metal halide lamp (manufactured by EYE GRAPHICS Co., Ltd.) at 160 W/cm, the composition was cured by being irradiated with ultraviolet rays at an iluminance of 400 mW/cm² and an irradiation amount of 500 mJ/cm², thereby forming the first cured layer. The first cured layer was then wound up.

<<Formation of Second Cured Layer>>

A surface of the support, on which the first cured layer was formed, opposite to the first cured layer was coated with the composition for forming a cured layer, and composition was cured in the same manner as in Formation of first cured layer. In this way, the second cured layer was formed, and hardcoat films of examples and comparative examples were formed.

[Evaluation of Hardcoat Film]

<Smoothness>

The films of examples and comparative examples were evaluated in terms of the flatness of the surface thereof on the first cured layer side. Specifically, an image of a fluorescent lamp reflected on the surface on which the first cured layer was formed was observed and evaluated as below.

A: the reflected image of the fluorescent lamp was not distorted.

B: the reflected image of the fluorescent lamp was distorted, and the distortion was problematic for practical use.

<Cutting Properties>

The films of examples and comparative examples were humidified for 2 hours at a temperature of 25° C. and a relative humidity of 60%, and then subjected to die cutting by using a die cutting machine (manual press machine TORC-PAC PRESS TP series manufactured by AMADA MACHINE TOOLS CO., LTD.) such that the punching blade was stuck into the film from the first cured layer side. The edges of the first cured layer side and the second cured layer side of the punched film were observed with an optical microscope and evaluated based on the following standards.

A: no crack was observed at the edges.

B: although a crack was observed at the edges, the length of the crack was less than 50 μm which is unproblematic for practical use.

C: although a crack was observed at the edges, the length of the crack was equal to or greater than 50 μm and less than 200 μm which is unproblematic for practical use.

D: A crack having a length of equal to or greater than 200 μm was observed at the edges, which is problematic for practical use.

<Pencil Hardness>

Pencil hardness was evaluated according to JIS K 5400.

The first cured layer-side surface of the films of examples and comparative examples was humidified for 2 hours at a temperature of 25° C. and a relative humidity of 60%%, and then 5 different sites on the surface to be evaluated were scratched under a load of 4.9 N by using a testing pencil with hardness of H to 9H specified in JIS S 6006.

Then, among the hardnesses of the pencil by which a visually recognized scratch was formed at 0 to 2 sites, the highest pencil hardness was taken as an evaluation result.

The evaluation results are shown in the following Table 3.

TABLE 2

| | Support | | | | | | Cured layer | | |
|---|---|---|---|---|---|---|---|---|---|
| | First layer | | Second layer | | Third layer | | First cured layer | | |
| | | Film | | Film | | Film | | Epoxy-based | Film |
| | | thickness | | thickness | | thickness | | compound | thickness |
| | Resin | (μm) | Resin | (μm) | Resin | (μm) | Formulation | (% by mass) | (μm) |
| Example 1 | PMMA | 20 | PC | 160 | PMMA | 20 | HC1 | 15% | 30 |
| Example 2 | PMMA | 20 | PC | 160 | PMMA | 20 | HC1 | 15% | 30 |
| Example 3 | PMMA | 20 | PC | 160 | PMMA | 20 | HC1 | 15% | 30 |
| Example 4 | PMMA | 20 | PC | 160 | PMMA | 20 | HC1 | 15% | 30 |
| Example 5 | PMMA | 20 | PC | 160 | PMMA | 20 | HC1 | 15% | 30 |
| Example 6 | PMMA | 20 | PC | 160 | PMMA | 20 | HC2 | 15% | 30 |
| Example 7 | PMMA | 20 | PC | 160 | PMMA | 20 | HC2 | 15% | 30 |
| Example 8 | PMMA | 20 | PC | 160 | PMMA | 20 | HC2 | 15% | 30 |
| Example 9 | PMMA | 60 | PC | 140 | — | — | HC2 | 15% | 30 |
| Example 10 | PMMA | 15 | PC | 170 | PMMA | 15 | HC2 | 15% | 30 |
| Example 11 | PMMA | 10 | PC | 180 | PMMA | 10 | HC2 | 15% | 30 |
| Example 12 | PMMA | 60 | PC | 80 | PMMA | 60 | HC2 | 15% | 30 |
| Example 13 | PMMA | 80 | PC | 40 | PMMA | 80 | HC2 | 15% | 30 |
| Example 14 | PMMA | 20 | PC | 160 | PMMA | 20 | HC1 | 15% | 20 |
| Example 15 | PMMA | 20 | PC | 160 | PMMA | 20 | HC1 | 15% | 10 |
| Example 16 | PMMA | 20 | PC | 60 | PMMA | 20 | HC2 | 15% | 30 |
| Example 17 | Tack | 20 | Tack | 160 | Tact | 20 | HC2 | 15% | 30 |
| Example 18 | PET | 20 | PET | 160 | PET | 20 | HC2 | 15% | 30 |
| Example 19 | PMMA | 20 | PC | 160 | PMMA | 20 | HC6 | 15% | 30 |
| Comparative | PMMA | 20 | PC | 160 | PMMA | 20 | HC3 | 0% | 30 |
| Example 1 | | | | | | | | | |
| Comparative | PMMA | 20 | PC | 160 | PMMA | 20 | HC1 | 15% | 30 |
| Example 2 | | | | | | | | | |
| Comparative | PMMA | 20 | PC | 160 | PMMA | 20 | HC1 | 15% | 30 |
| Example 3 | | | | | | | | | |
| Comparative | PMMA | 20 | PC | 160 | PMMA | 20 | HC1 | 15% | 30 |
| Example 4 | | | | | | | | | |

| | Cured Layer | | | | | |
|---|---|---|---|---|---|---|
| | Second cured layer | | | | Film | |
| | | Epoxy-based | (meth)acryloyl- | Film | thickness | Total film |
| | | compound | based compound | thickness | ratio | thickness |
| | Formulation | (% by mass) | (% by mass) | (μm) | (T1/T2) | (μm) |
| Example 1 | HC3 | 0% | 95 | 25 | 1.2 | 255 |
| Example 2 | HC3 | 0% | 95 | 20 | 1.5 | 250 |
| Example 3 | HC3 | 0% | 95 | 15 | 2.0 | 245 |
| Example 4 | HC3 | 0% | 95 | 10 | 3.0 | 240 |
| Example 5 | HC3 | 0% | 95 | 5 | 6.0 | 235 |
| Example 6 | HC3 | 0% | 95 | 15 | 2.0 | 245 |
| Example 7 | HC4 | 0% | 80 | 15 | 2.0 | 245 |
| Example 8 | HC5 | 10% | 69 | 15 | 2.0 | 245 |
| Example 9 | HC3 | 0% | 95 | 15 | 2.0 | 245 |
| Example 10 | HC3 | 0% | 95 | 15 | 2.0 | 245 |
| Example 11 | HC3 | 0% | 95 | 15 | 2.0 | 245 |
| Example 12 | HC3 | 0% | 95 | 15 | 2.0 | 245 |
| Example 13 | HC3 | 0% | 95 | 15 | 2.0 | 245 |
| Example 14 | HC3 | 0% | 95 | 10 | 2.0 | 230 |
| Example 15 | HC3 | 0% | 95 | 5 | 2.0 | 215 |
| Example 16 | HC3 | 0% | 95 | 15 | 2.0 | 145 |
| Example 17 | HC3 | 0% | 95 | 15 | 2.0 | 245 |
| Example 18 | HC3 | 0% | 95 | 15 | 2.0 | 245 |
| Example 19 | HC7 | 0% | 80 | 15 | 2.0 | 245 |
| Comparative | HC3 | 0% | 95 | 15 | 2.0 | 245 |
| Example 1 | | | | | | |
| Comparative | HC3 | 0% | 95 | 30 | 1.0 | 260 |
| Example 2 | | | | | | |
| Comparative | HC1 | 15% | 64 | 15 | 2.0 | 245 |
| Example 3 | | | | | | |
| Comparative | HC3 | 0% | 95 | 4 | 7.5 | 234 |
| Example 4 | | | | | | |

TABLE 3

| | Evaluation | | | |
|---|---|---|---|---|
| | | Cutting properties | | |
| | Smooth- | Edge cracking of | Edge cracking of | Hard- |
| | ness | first cured layer | second cured layer | ness |
| Example 1 | A | C | C | 6H |
| Example 2 | A | B | B | 6H |
| Example 3 | A | A | A | 6H |
| Example 4 | A | B | A | 6H |
| Example 5 | A | C | A | 6H |
| Example 6 | A | B | A | 6H |
| Example 7 | A | B | A | 6H |
| Example 8 | A | B | A | 6H |
| Example 9 | A | B | A | 7H |
| Example 10 | A | A | A | 5H |
| Example 11 | A | A | A | 4H |
| Example 12 | A | B | A | 7H |
| Example 13 | A | C | A | 9H |
| Example 14 | A | A | A | 5H |
| Example 15 | A | A | A | 4H |
| Example 16 | A | A | A | 4H |
| Example 17 | A | A | A | 6H |
| Example 18 | A | A | A | 6H |
| Example 19 | A | A | A | 6H |
| Comparative | B | A | A | 7H |
| Example 1 | | | | |
| Comparative | A | A | D | 6H |
| Example 2 | | | | |
| Comparative | A | D | A | 6H |
| Example 3 | | | | |
| Comparative | A | D | A | 6H |
| Example 4 | | | | |

As shown in Tables 1 to 3, the hardcoat films of the present examples have excellent surface smoothness and excellent cutting properties.

### INDUSTRIAL APPLICABILITY

According to the present invention it is possible to provide a hardcoat film having excellent surface smoothness and excellent cutting properties. Furthermore, according to the present invention, it is possible to provide a front plate of an image display element, a resistive film-type touch panel, a capacitance-type touch panel, and an image display in which the hardcoat film is used.

Hitherto, the present invention has been described with reference to detailed and specific embodiments. Those skilled in the art clearly knows that the present invention can be changed or modified in various ways without departing from the gist and scope of the present invention.

What is claimed is:

1. A hardcoat film comprising at least:
a first cured layer;
a support; and
a second cured layer in this order,
wherein the first cured layer contains a cured substance of an epoxy group-containing curable compound,
the second cured layer contains a cured substance of a (meth)acryloyl group-containing curable compound,
a content rate of the cured substance of the epoxy group-containing curable compound in the second cured layer is lower than a content rate of the cured substance of the epoxy group-containing curable compound in the first cured layer, and
Expression (1) is satisfied.
7>(film thickness of first cured layer/film thickness of second cured layer)>1 Expression (1):

2. The hardcoat film according to claim 1, comprising:
a compound having an alicyclic structure as the epoxy group-containing curable compound.

3. The hardcoat film according to claim 1,
wherein a content rate of inorganic particles in the second cured layer is equal to or lower than 10% by mass.

4. The hardcoat film according to claim 1,
wherein the support has at least a first layer, a second layer, and a third layer in this order.

5. The hardcoat film according to claim 4,
wherein the second layer is formed of a material different from materials of the first layer and the third layer, and
a film thickness of the first layer and the third layer is equal to or greater than 15 μm and less than 60 μm.

6. The hardcoat film according to claim 5,
wherein the first layer and the third layer are formed of the same material.

7. A front plate of an image display comprising:
the hardcoat film according to claim 1.

8. A resistive film-type touch panel comprising:
the front plate according to claim 7.

9. A capacitance-type touch panel comprising:
the front plate according to claim 7.

10. An image display comprising:
the front plate according to claim 7; and
an image display element.

11. The image display according to claim 10,
wherein the image display element is a liquid crystal display element.

12. The image display according to claim 10,
wherein the image display element is an organic electroluminescence display element.

13. The image display according to claim 10,
wherein the image display element is an in-cell touch panel display element.

14. The image display according to claim 10,
wherein the image display element is an on-cell touch panel display element.
